(19) United States
(12) Patent Application Publication
(10) Pub. No.: US 2024/0201571 A1
(43) Pub. Date: Jun. 20, 2024

(54) ADAPTER, PROJECTION SYSTEM, AND STAND

(71) Applicant: SEIKO EPSON CORPORATION, Tokyo (JP)

(72) Inventors: Yusaku TAKAMINE, Azumino-Shi (JP); Kosuke TABAYASHI, Azumino-Shi (JP); Yoshitsugu AKUTAGAWA, Azumino-Shi (JP)

(21) Appl. No.: 18/539,714

(22) Filed: Dec. 14, 2023

(30) Foreign Application Priority Data
Dec. 16, 2022 (JP) 2022-200937

(51) Int. Cl. G03B 21/14; H01R 31/06

(52) U.S. Cl. CPC G03B 21/145; H01R 31/06

(57) ABSTRACT

An adapter includes a first terminal attachable to and detachable from an electric contact provided at a ceiling and an electric contact provided at a stand, and a second terminal coupled to a projector that projects image light. The second terminal supplies electricity via the first terminal to the projector.

The present application is based on, and claims priority from JP Application Serial Number 2022-200937, filed Dec. 16, 2022, the disclosure of which is hereby incorporated by reference herein in its entirety.

### BACKGROUND

### 1. Technical Field

The present disclosure relates to an adapter, a projection system, and a stand.

### 2. Related Art

JP A-2004-233692 discloses a projector apparatus that includes a projector fixed to a power supply outlet disposed at the ceiling of a room via a hook plug and receives power for driving the projector supplied from the power supply outlet.

JP A-2005-121918 discloses an angle adjustment table apparatus that allows a projector that projects image light to be placed on a swingable frame that shakes like head shaking.

JP A-2004-233692 is an example of the related art. JP A-2005-121918 is another example of the related art.

The technology described in JP A-2004-233692, in which power is supplied from the power supply outlet disposed at the ceiling of the room, however, has a problem of installation of the projector, that is, the projector can be installed only at the ceiling. The technology described in JP A-2005-121918 has an installation problem, that is, the projector cannot be readily installed at the ceiling when the ceiling has no portion to which the projector is fixed or the ceiling has no power supply outlet. That is, there is a problem of a small flexibility of installation of the projector.

### SUMMARY

An adapter includes a first terminal attachable to and detachable from a first electric contact provided at a wall, and a second electric contact provided at a stand, and a second terminal via which electricity is supplied via the first terminal to a projector that projects image light, the second terminal coupled to the projector.

A projection system includes a projector that projects image light, and an adapter attachable to and detachable from a first electric contact provided at a wall, and a second electric contact provided at a stand, and the adapter is disposed so as to be attachable to and detachable from the projector.

A projection system includes a stand having a first electric contact, and an adapter attachable to and detachable from a second electric contact provided at a wall, and the first electric contact provided at the stand, and the adapter includes a first terminal to which electricity is supplied via the first electric contact when the adapter is coupled to the first electric contact, and to which electricity is supplied via the second electric contact when the adapter is coupled to the second electric contact, and a second terminal which is coupled to a projector that projects image light, and via which electricity is supplied to the projector via the first terminal.

A stand includes an adapter which is attachable to and detachable from a first electric contact provided at a wall and at which a projector that projects image light is installed, a leg that supports the adapter, and an installation part that is installed at an installation surface and supports the leg, and one of the adapter and the leg has a second electric contact.

A projection system includes an adapter including a first terminal attachable to and detachable from a first electric contact provided at a wall, a stand having a second electric contact attachable to and detachable from the first terminal, and a projector which is attachable to and detachable from the adapter and to which electricity is supplied via the first electric contact or the second electric contact through the adapter.

### BRIEF DESCRIPTION OF THE DRAWINGS

FIG. 1 is a cross-sectional view showing the configuration of a first projection system that is an example of a projection system.

FIG. 2 is a cross-sectional view showing the configuration of a second projection system that is another example of the projection system.

FIG. 3 is a side view showing the configuration of an adapter.

FIG. 4 is a cross-sectional perspective view showing the configuration of the adapter.

FIG. 5 is a perspective view showing the configuration of the adapter.

FIG. 6 is a cross-sectional view showing an example of the coupling between the adapter and a projector.

FIG. 7 is a cross-sectional view showing another example of the coupling between the adapter and a projector.

FIG. 8 is a cross-sectional view showing the configuration of the projection system according to a variation.

FIG. 9 is a cross-sectional view showing the configuration of the projection system according to another variation.

FIG. 10 is a cross-sectional perspective view showing an example of the coupling between the adapter and the projector according to another variation.

FIG. 11 is an enlarged view of the portion within the imaginary line shown in FIG. 10.

FIG. 12 is a perspective view showing the configuration of the adapter according to another variation.

### DESCRIPTION OF EMBODIMENTS

In the following drawings, three axes perpendicular to one another are called an axis X, an axis Y, and an axis Z in the description. The direction along the axis X is a “direction X”, the direction along the axis Y is a “direction Y”, and the direction along the axis Z is a “direction Z”, with the direction toward the end indicated by the arrow being the direction toward the positive end thereof, the opposite direction of the direction toward the positive end thereof being the direction toward the negative end. The direction Z toward the positive end thereof may be referred to as “upper”, “upward”, or a “front side”, the direction Z toward the negative end may be referred to as “lower”, “downward”, or a “rear side”, and the views in the directions Z toward the positive and negative ends thereof are referred to as a plan or planar view. The description below will be made with a surface facing the positive end of the direction Z referred to as an “upper surface” or a “front surface”, and a surface facing the negative end of the direction Z, which is the surface opposite from the surface facing the positive end of the direction Z, referred to as a “lower surface” or a “rear surface”.

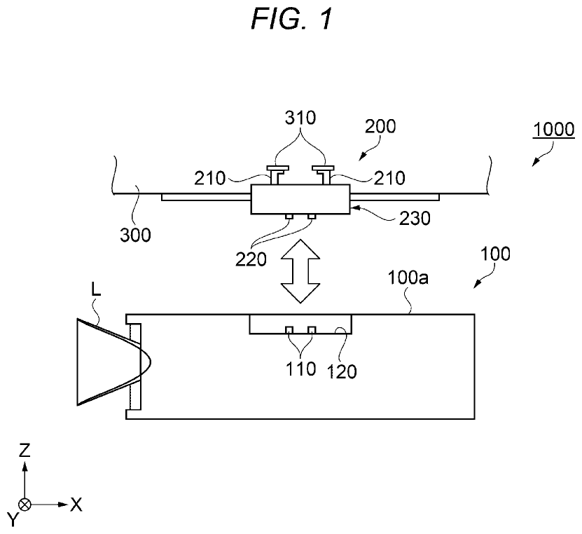

The configuration of a first projection system 1000, which is an example of a projection system, will first be described with reference to FIG. 1.

The first projection system 1000 includes a projector 100 and an adapter 200, which is caused to engage with the projector 100, as shown in FIG. 1.

The projector 100 of the first projection system 1000 is installed at a ceiling 300 as a wall, and projects image light L from the side facing the ceiling 300, for example, onto a screen. The projector 100 can be installed at the ceiling 300 via the adapter 200 with electricity supplied from the ceiling 300 to the projector 100.

The adapter 200 includes first terminals 210, which are attachable to and detachable from electric contacts 310 provided at the ceiling 300, and second terminals 220, via which electricity is supplied to the projector 100 via the first terminals 210. The second terminals 220 are electrically coupled to third terminals 110 provided at the projector 100. The electric contacts 310 provided at the ceiling 300 and the first terminals 210 are coupled to each other by a ceiling structure. For example, either the electric contacts 310 or the first terminals 210 may function as ceiling hooks, and the other may have a structure including terminals electrically coupled to the ceiling hooks.

The projector 100 is provided with a recess 120 in an upper portion of an enclosure 100a. The third terminals 110, via which electricity is supplied from the adapter 200, are disposed in the recess 120. Since the third terminals 110 are disposed in the recess 120 as described above, the enclosure 100a can hide the third terminals 110, which are electric contacts of the projector 100, so that the exterior appearance of the projector 100 can be improved.

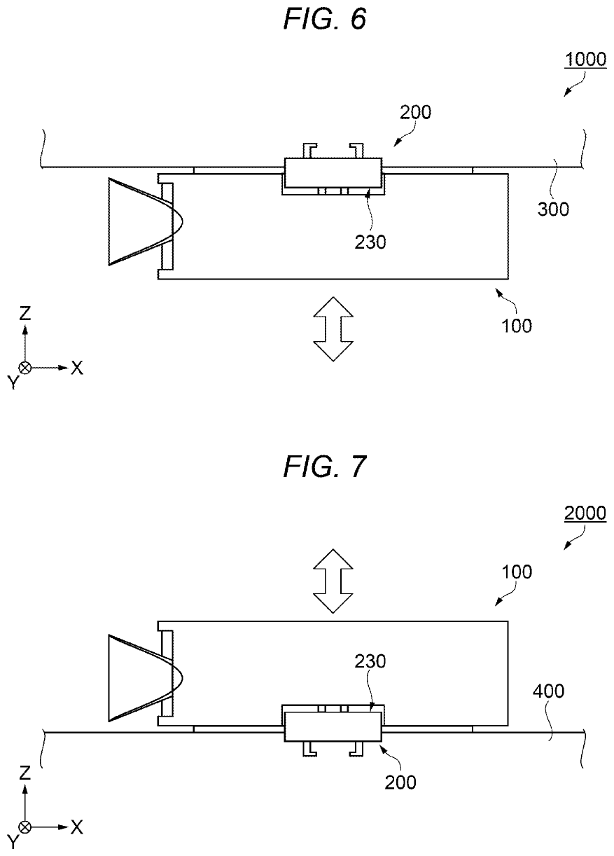

A lower portion of the adapter 200 has a protrusion 230 as a coupler. The protrusion 230 is provided with the first terminals 210 and the second terminals 220, which are electric contacts. The protrusion 230 is sized to be fitted into the recess 120 provided in the projector 100. That is, the size of the protrusion 230 in the direction X toward the positive end thereof is smaller than the radial size of the recess in the direction X toward the positive end thereof. Since the projector 100 is provided with the recess 120, and the adapter 200 is provided with the protrusion 230, as described above, the protrusion 230 of the adapter 200 can be fitted into the recess 120 of the projector 100, so that the projector 100 can be readily coupled to the adapter 200 (see FIG. 6).

The adapter 200 and the projector 100 are fixed to each other, for example, by using a fixing method using a screw structure or any other structure. Note that the fixing method may not necessarily use a screw structure or any other structure, and the adapter 200 and the projector 100 may be fixed to each other by using any other method that allows the two components are attachable to and detachable from each other.

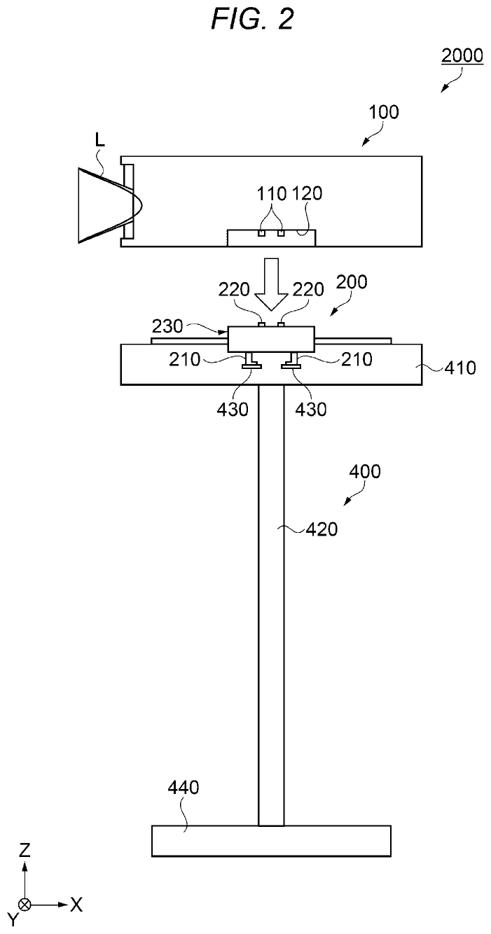

The configuration of a second projection system 2000, which is another example of the projection system, will next be described with reference to FIG. 2.

The second projection system 2000 includes a stand 400, the projector 100 placed on the stand 400, and the adapter 200, which couples the stand 400 and the projector 100 to each other, as shown in FIG. 2.

The projector 100 of the second projection system 2000 is installed on the stand 400, and projects the image light L from the upper side of the stand 400, for example, onto a screen. The projector 100 can be installed on the stand 400 by using the same adapter 200 as the adapter 200 used in the first projection system 1000. That is, the adapter 200 can be used for both the first projection system 1000 and the second projection system 2000.

The stand 400 includes a placement table 410, on which the projector 100 is placed, a leg 420, which supports the placement table 410, and an installation part 440, which supports the leg 420, as well as the adapter 200. The installation part 440 of the stand 400 is installed on the ground or any other surface as an installation surface. The installation part is formed of a substantially-disk-shaped member. The placement table 410 includes electric contacts 430 electrically coupled to the first terminals 210 of the adapter 200.

The projector 100 is installed on the stand 400 by coupling the adapter 200 to the placement table 410 and then coupling the second terminals 220 of the adapter 200 to the third terminals 110 of the projector 100.

In the second projection system 2000, in which the projector 100 is provided with the recess 120, and the adapter 200 is provided with the protrusion 230, the protrusion 230 of the adapter 200 can be fitted into the recess 120 of the projector 100, so that the projector 100 can be readily coupled to the adapter 200 (see FIG. 7), as in the first projection system 1000.

The adapter 200 and the projector 100 are fixed to each other, for example, by using a fixing method using a screw structure or any other structure, as in the first projection system 1000.

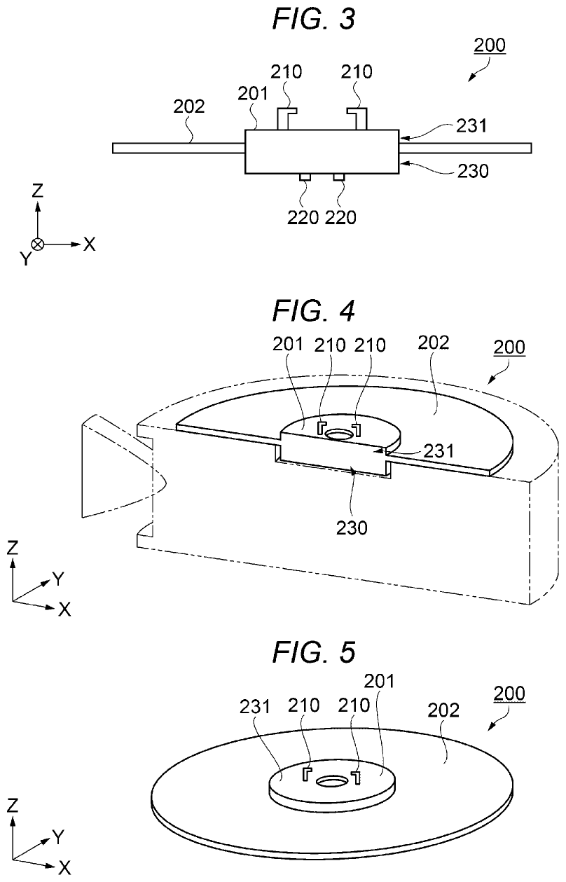

The configuration of the adapter 200 will next be described with reference to FIGS. 3, 4, and 5.

The adapter 200 is formed, for example, in a substantially disc shape, as shown in FIGS. 3, 4, and 5. A central section 201 of the adapter 200 is thicker than the portion therearound. The central section 201 has the protrusion 230 described above. The second terminals 220 are provided at the protrusion 230.

The first terminals 210 are provided at a protrusion 231, which is a rear protrusion with respect to the protrusion 230, which is a front protrusion. An extension 202, which extends outward from the central section 201 along the enclosure 100a of the projector 100, is formed to cause the adapter 200 to come into contact with the projector 100 and the ceiling 300 or the stand 400 in a well-balanced and uniform manner.

The first terminals 210 are attachable to and detachable from the electric contacts 310 (see FIG. 1) provided at the ceiling 300 and the electric contacts 430 (see FIG. 2) provided at the stand 400, as described above. The second terminals 220 are used to supply the projector 100, which projects the image light L, with electricity via the first terminals 210, and coupled to the projector 100.

Since the adapter 200 includes the thus configured first terminals 210 and second terminals 220, attaching the first terminals 210 to the electric contacts 310 at the ceiling 300 allows the projector 100 to be placed at the ceiling 300 via the second terminals 220, or attaching the first terminals 210 to the electric contacts 430 of the stand 400 allows the projector 100 to be placed on the stand 400 via the second terminals 220. That is, using the adapter 200 including the first terminals 210 and the second terminals 220 allows an increase in flexibility of installation of the projector 100.

As described above, the adapter 200 according to the present embodiment includes the first terminals 210, which are attachable to and detachable from the electric contacts 310 provided at the ceiling 300 and the electric contacts 430 provided at the stand 400, and the second terminals 220, which supply the projector 100, which projects the image light L, with electricity via the first terminals 210 and are coupled to the projector 100.

According to the configuration described above, in which the first terminals 210 and the second terminals 220 are provided, attaching the first terminals 210 to the electric contacts 310 at the ceiling 300 allows the projector 100 to be placed at the ceiling 300 via the second terminals 220, or attaching the first terminals 210 to the electric contacts 430 of the stand 400 allows the projector 100 to be placed on the stand 400 via the second terminals 220. That is, using the adapter 200 including the first terminals 210 and the second terminals 220 allows an increase in flexibility of installation of the projector 100.

The projection systems 1000 and 2000 according to the present embodiment each include the projector 100, which projects the image light L, and the adapter 200, which is attachable to and detachable from the electric contacts 310 provided at the ceiling 300 and the electric contacts 430 provided at the stand 400, and the adapter 200 is disposed to be attachable to and detachable from the projector 100.

The configuration described above, in which the projector 100 and the adapter 200 are provided, allows the projector 100 to be placed on the stand 400 via the adapter 200. Using the adapter 200 further allows the projector 100 to be placed at the ceiling 300.

In the projection systems 1000 and 2000 according to the present embodiment, it is preferable that the enclosure 100a of the projector 100 is provided with the recess 120, and that the third terminals 110, via which electricity is supplied, are disposed in the recess 120. According to the configuration described above, in which the third terminals 110 are disposed in the recess 120, the enclosure 100a can hide electric contacts of the projector 100, that is, the third terminals 110, so that the exterior appearance of the projector 100 can be improved.

Furthermore, in the projection systems 1000 and 2000 according to the present embodiment, it is preferable that the adapter 200 has the protrusion 230, and that the protrusion 230 is provided with electric contacts, that is, the second terminals 220. According to the configuration described above, in which the adapter 200 is provided with the protrusion 230, the protrusion 230 can function as a guide that causes the protrusion 230 of the adapter 200 to be fitted into the recess 120 of the projector 100, so that the projector 100 can be readily coupled to the adapter 200.

The second projection system 2000 according to the present embodiment includes the stand 400, which has the electric contacts 430, and the adapter 200, which is detachably coupled to the electrical contacts 310 provided at the ceiling 300 and the electric contacts 430 provided at the stand 400, and supplies the projector 100 with electricity via the electric contacts 430.

The configuration described above, in which the stand 400 and the adapter 200 are provided, allows the projector 100 to be placed on the stand 400 via the adapter 200. Furthermore, since the adapter 200 has common electric contacts, that is, the first terminals 210 and the second terminals 220, the projector 100 can also be placed at the ceiling 300 via the adapter 200.

The stand according 400 to the present embodiment includes the adapter 200, which is attachable to and detachable from the electric contacts 310 provided at the ceiling 300, and at which the projector 100, which projects the image light L, is installed, and the leg 420, which supports the adapter 200, and the adapter 200 includes the first terminals 210.

The configuration described above, in which the adapter 200 includes the first terminals 210, allows the projector 100 to be placed on the stand 400 via the adapter 200.

In the stand 400 according to the present embodiment, it is preferable that the adapter 200 includes the first terminals 210, which can be coupled to the electric contacts 310 provided at the ceiling 300, and that the adapter s disposed to be attachable to and detachable from the leg 420. That is, the adapter 200 is configured to be attachable to and detachable from the placement table 410, but not necessarily, and electric contacts having the same structure as that of the electric contacts 310 provided at the wall of the leg 420 may be provided, so that the adapter 200 may be attachable and detachable via the electric contacts at the leg 420. According to the configuration described above, the adapter 200 can function as a placement table on which the projector 100 is placed, includes the first terminals 210, and is detachably disposed, so that the adapter 200 can be removed from the stand 400, and the adapter 200 can be disposed at the ceiling 300.

The second projection system 2000 according to the present embodiment includes the adapter 200, which is attachable to and detachable from the electrical contacts 310 provided at the ceiling 300, the stand 400 having the electrical contacts 430, and the projector 100 attachable to and detachable from the adapter 200.

The configuration described above, in which the adapter 200, the stand 400, and the projector 100 are provided, allows the projector 100 to be placed on the stand 400 via the adapter 200. Using the adapter 200 further allows the projector 100 to be placed at the ceiling 300.

Variations of the embodiment described above will be described below.

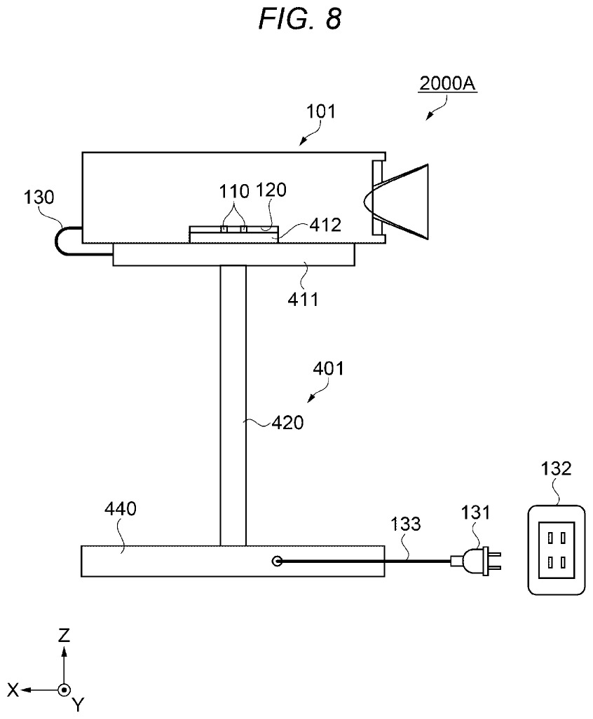

As described above, the adapter 200 is not necessarily disposed at the stand 400 in a detachable manner, and the leg 420 of a stand 401 may be configured to have the function of the adapter 200. Note that the leg 420 in this case includes a placement table 411. Specifically, for example, the placement table 411 supported by the leg 420, as shown in FIG. 8, is provided with the second terminals 220 (not shown in FIG. 8).

As described above, the stand 401 of a projection system 2000A according to a variation includes the leg 420, at which a projector 101, which projects the image light L, is installed, and the leg 420 includes the second terminals 220.

The configuration described above, in which the leg 420 includes the second terminals 220, also allows the projector 101 to be placed on the stand 401 without via the adapter 200.

A structure in which the stand 401 includes a power cable 133, as shown in FIG. 8, may be employed. Specifically, a power cable 130, with which the projector 101 is provided, is coupled to the placement table 411. The power cable 133 electrically coupled to the power cable 130 passes through the placement table 411 and the leg 420 and is linked to a power plug 131. The power plug 131 may be coupled to an outlet 132.

According to the configuration described above, even the projector 101, which is a variation of the projector 100 including the power cable 130 disposed at the side surface thereof, can be installed on the stand 401. Furthermore, the stand 401 can hide the power cables 130 and 133, so that the exterior appearance of the stand 401 can be improved. To install the projector 101, for example, at the ceiling 300, the third terminals 110 in the recess 120 may be used for ceiling coupling.

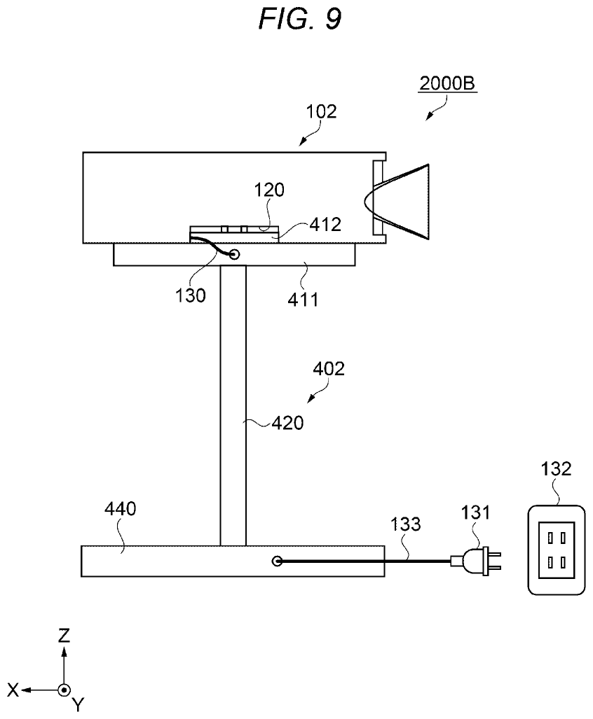

Even when the power cable 130 is disposed in the recess 120 of the projector 102, the power cables 130 and 133 may be coupled to each other, and the power cable 133 may be linked to the power plug 131 through the placement table 411 and the leg 420 of the stand 402, and the power plug 131 may be coupled to the outlet 132, as shown in FIG. 9.

When the projection system 2000A shown in FIG. 8 and or a projection system 2000B shown in FIG. 9 is used, the stand 401 or 402 may not be provided with a ceiling hook structure. The recess 120 provided in the projector 101 may be used to position the stand 401 and the projector 101, and the recess 120 provided in the projector 102 may be used to position the stand 402 and the projector 102. In this case, it is desirable to provide the placement table 411 with a protrusion 412, which can be fitted into the recess 120.

Note that the protrusion 412 of each of the stands 401 and 402, which is inserted into the recess 120 of each of the projectors 101 and 102, may be disposed so as to be in contact with the recess 120 or separate from the recess 120. Instead, the placement table 411 may be fixed to each of the projectors 101 and 102 via a screw structure.

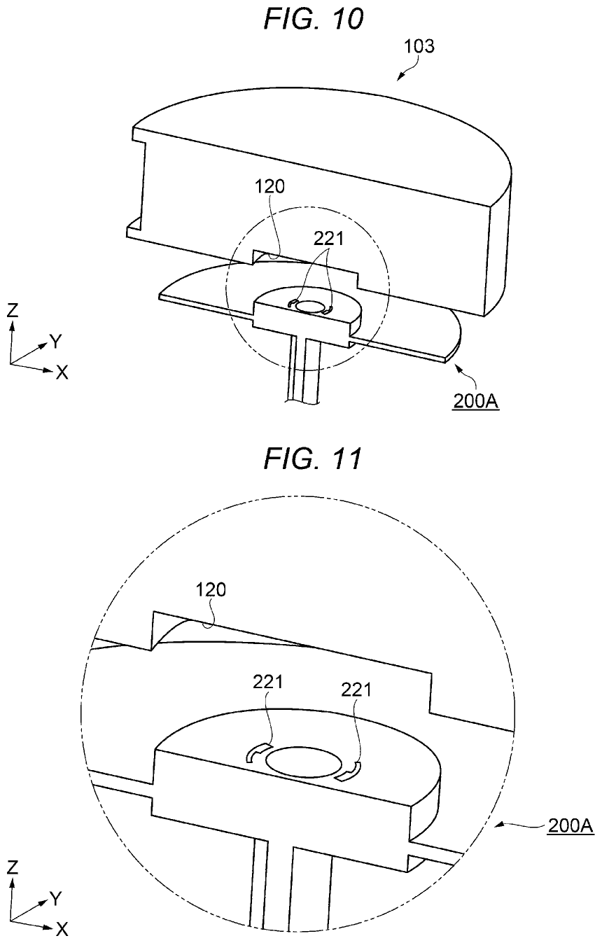

Unlike the configuration described above, the second terminals 220, which are provided at the adapter 200 and each have a protruding shape, and the third terminals 110, which are provided in the recess 120 of the projector 100 and each have a protruding shape, may not be in contact with each other for electrical coupling, but the configuration shown in FIGS. 10 and 11 may be employed.

Specifically, in an adapter 200A according to a variation, the portions corresponding to the second terminals 220 are recessed coupling terminals 221 for ceiling hook, as shown in FIGS. 10 and 11. On the other hand, the recess 120 of a projector 103 is provided with protruding coupling terminals for ceiling hook that are not shown. The configuration described above allows, for example, the adapter 200A and the projector 103 to be fixed to each other by using the ceiling hooks without fixing the two components to each other, for example, by using a screw structure.

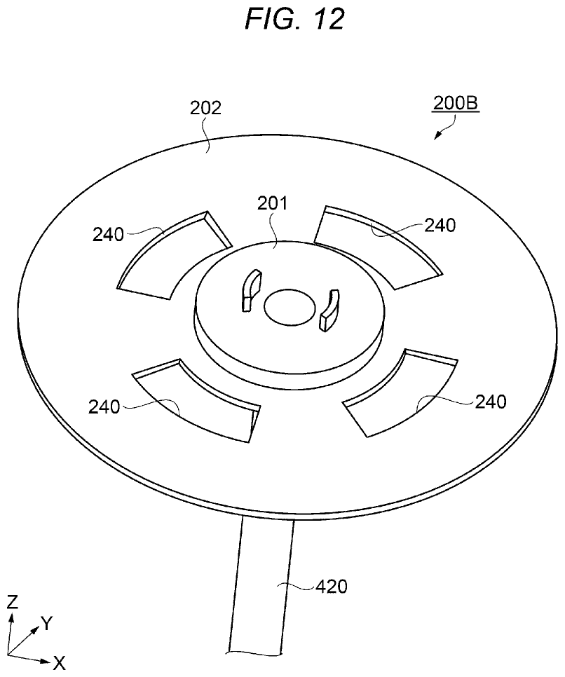

Openings 240 may be formed in the extension 202 of an adapter 200B, as shown in FIG. 12. Specifically, the enclosure 100a of the projector 100 is provided with intake ports that are not shown. The adapter 200B according to a variation is provided with the openings 240 at the positions corresponding to the intake ports in the state in which the projector 100 is coupled to the adapter 200B. The extension 202 of the adapter 200B therefore does not interfere with the air having sucked via the intake ports, so that the air can be smoothly sucked.

The openings 240 of the adapter 200B are not necessarily used to suck air, and may be used to prevent the extension 202 from blocking the light output from an illuminator that is not shown but is provided in the projector 100.

As described above, it is preferable in the adapter 200B according to the variation that the enclosure 100a of the projector 100 are provided with intake ports, and that the adapter 200B has the openings 240 at the positions corresponding to the intake ports. According to the configuration described above, in which the openings 240 are provided, a decrease in the air intake capability of the projector 100 can be suppressed even when the projector 100 is caused to engage with the adapter 200B.

It is preferable in the adapter 200B according to the variation that the projector 100 includes an illuminator and has the openings 240 at the positions corresponding to the illuminator. According to the configuration described above, in which the adapter 200B is provided with the openings 240, blockage of the light output from the projector 100 can be suppressed even when the projector 100 is caused to engage with the adapter 200B.

Unlike the configuration described above, the placement table 410 is not necessarily provided with the electric contacts 430, and when the placement table 410 is not provided, the leg 420 may be provided with the electric contacts 430.

What is claimed is:

1. An adapter comprising:
a first terminal attachable to and detachable from a first electric contact provided at a wall, and a second electric contact provided at a stand; and
a second terminal coupled to a projector that projects image light,
wherein the second terminal supplies electricity via the first terminal to the projector.

2. The adapter according to claim 1, further comprising:
a coupler provided with the first terminal and the second terminal; and
an extension extending from the coupler along an enclosure of the projector,
wherein the extension is provided with an opening disposed at a position corresponding to an intake port of the enclosure.

3. The adapter according to claim 1, further comprising:
a coupler provided with the first terminal and the second terminal; and
an extension extending from the coupler along an enclosure of the projector,
wherein the extension is provided with an opening disposed at a position corresponding to an illuminator provided in the projector.

4. A projection system comprising:
a projector that projects image light; and
an adapter attachable to and detachable from a first electric contact provided at a wall, and a second electric contact provided at a stand,
wherein the adapter is disposed so as to be attachable to and detachable from the projector.

5. The projection system according to claim 4,
wherein the adapter includes
a first terminal to which electricity is supplied via the first electric contact when the adapter is coupled to the first electric contact, and to which electricity is supplied via the second electric contact when the adapter is coupled to the second electric contact, and
a second terminal coupled to the projector,
an enclosure of the projector is provided with a recess, and
a third terminal which is coupled to the second terminal and to which electricity is supplied via the second terminal is disposed in the recess,
wherein the second terminal supplies electricity via the first terminal to the projector.

6. The projection system according to claim 5,
wherein the adapter has a protrusion, and
the protrusion is provided with the second terminal.

7. The projection system according to claim 4,
further comprising a stand,
wherein the adapter includes
a first terminal to which electricity is supplied via the first electric contact when the adapter is coupled to the first electric contact, and to which electricity is supplied via the second electric contact when the adapter is coupled to the second electric contact, and
a second terminal coupled to the projector, and
the second terminal supplies electricity via the first terminal to the projector.

8. The projection system according to claim 7,
wherein the adapter includes
a coupler provided with the first terminal and the second terminal; and
an extension extending from the coupler along an enclosure of the projector, and
the extension is provided with an opening disposed at a position corresponding to an intake port of the enclosure.

9. The projection system according to claim 7,
wherein the adapter includes
a coupler provided with the first terminal and the second terminal; and
an extension extending from the coupler along an enclosure of the projector, and
the extension is provided with an opening disposed at a position corresponding to an illuminator provided in the projector.

10. A stand comprising:
an adapter which is attachable to and detachable from a first electric contact provided at a wall and at which a projector that projects image light is installed;
a leg that supports the adapter; and
an installation part that is installed at an installation surface and supports the leg,
wherein one of the adapter and the leg has a second electric contact.

11. The stand according to claim 10,
wherein the second electric contact is provided at the leg, and
the adapter includes a first terminal configured to be coupled to the first electric contact provided at the wall, and disposed so as to be attachable to and detachable from the leg.
